(19) United States
(12) Patent Application Publication
(10) Pub. No.: US 2014/0144547 A1
(43) Pub. Date: May 29, 2014

(54) JAR BUDDY

(71) Applicant: LAURA ROSEMAN, China Grove, NC (US)

(72) Inventor: LAURA ROSEMAN, China Grove, NC (US)

(21) Appl. No.: 13/686,892

(22) Filed: Nov. 27, 2012

(51) Int. Cl. B67C 11/02

(52) U.S. Cl. CPC B67C 11/02
USPC 141/340

(57) ABSTRACT

A funnel for pouring a substance into and out of a canning jar having an externally threaded mouth which includes a hollow conical member having a large top end and a small bottom end. A collar is formed about the small bottom end of the hollow conical member. The collar has internal threads that screw onto the externally threaded mouth of the canning jar, thereby allowing the substance to be poured through the hollow conical member and into the canning jar. A pour spout is formed onto and extends downwardly from the large top end to the small bottom end of the hollow conical member, thereby allowing the substance to be poured easily out of the canning jar via the pour spout into a container.

### CROSS-REFERENCE TO RELATED APPLICATION

This application claims the benefit of Provisional Patent Application No. 61/63,826, filed on Nov. 27, 2011, in the United States Patent & Trademark Office, the disclosure of which is incorporated herein by reference.

### BACKGROUND OF THE INVENTION

1. Field of the Invention

The present invention relates to a funnel, and more particularly, a funnel for transferring a substance into and out of a canning jar.

Pouring a substance into a canning jar is difficult to do without making a mess. A consumer may choose to use an ordinary funnel, but it tends to tip and shift, making it unstable. Pouring a substance, especially liquids, out of the canning jar is also troublesome and messy. The mouth of the canning jar is manufactured in such a way that liquids tend to spill and run down the side of the canning jar. Additionally, the lids of the canning jars are made of metal and tend to rust over time and during regular usage. Consumers need a more effective way of filling up and pouring liquids out of the canning jar.

The present invention provides consumers with a funnel that makes it easier to pour substances out of or into a canning jar. The funnel has a collar at a bottom end of a hollow conical member that is internally threaded and can easily screw onto a mouth of the canning jar. The large top end of the hollow conical member of the funnel is provided with a pour spout as well. The funnel may come in a variety of colors and patterns to suit individual tastes and includes a lid for easy storage. The present invention is ideal for people who would appreciate a mess-free option when using canning jars to store fresh milk, sauces, soups, other foods and storing extra hobby supplies, such as paint.

2. Description of the Prior Art Numerous innovations for funnels have been provided in the prior art that will be described. Even though these innovations may be suitable for the specific individual purposes to which they address, however, they differ from the present invention.

A FIRST EXAMPLE, U.S. Pat. No. 3,982,570, Issued on Sep. 28, 1976, to Devoe teaches a funnel, particularly designed for filling canning jars and the like which includes a wide mouthed receiving end and a comparatively small mouthed delivery end which delivery end is designed to be received into a canning jar with an area adjacent the delivery end formed to provide a locating stop against the top of the jar to be filled such that the delivery end will extend into the jar a predetermined distance. The delivery end of the funnel is provided with a level marking indicia interiorially thereof whereby filling of the jar to either this predetermined level or to the bottom of the funnel will provide a proper expansion and contraction area between the foodstuff in the jar and the lid or cover that is placed on the jar.

A SECOND EXAMPLE, U.S. Pat. No. 5,762,120, Issued on Jun. 9, 1998, to Smith teaches a threaded jar funnel for easy pouring of material into a jar, without leakage or spillage, has an upper part, with upper and lower conical segments, and a lower cylindrical part having threads on the inside. The upper conical segment of the upper part has a small angle to the vertical and the lower conical segment has a larger angle to the vertical than the upper conical segment. The upper conical segment merges into the lower conical segment to provide an aesthetically pleasing appearance, larger funnel capacity and smoother flow of contents into a jar coupled to the funnel. The lower cylindrical threaded part has a rim, which provides a tight seal when the funnel is coupled to a jar.

A THIRD EXAMPLE, U.S. Pat. No. 6,425,424, Issued on Jul. 30, 2002, to Ellis Calvo et al. teaches a series of multi-use funnels are designed to attach by threads or pressure fit to a variety of threaded or non-threaded fill openings of bottles or containers. Two or more concentric female threaded or friction engaging connectors are located at the discharge opening of the funnel. The innermost connector is the smaller or smallest and each size is graduated outward therefrom. A secondary funnel is located inside of the innermost female threaded connector to direct fluid into the attached container below the junction of the top of the bottle of container and the first threads. A sealing annular ring or step is located at each connector portion. Single diameter versions are shown as well as slip-on versions for use with threaded, snap-on or straight sided bottle filling openings.

A FOURTH EXAMPLE, U.S. Patent Office Publication No. 2008/0053566, Published on Mar. 6, 2008, to England teaches an improved funnel which allows for easier filling of containers. The funnel allows containers to be filled more completely and to be more easily filled with viscous or granulated material. The funnel is also stabilized during use to minimize the risk of spilling.

A FIFTH EXAMPLE, U.S. Patent Office Document No. D629,269, Issued on Dec. 21, 2010, to Okamoto teaches an ornamental design for a canning funnel, as shown and described.

It is apparent now that numerous innovations for funnels have been provided in the prior art that are adequate for various purposes. Furthermore, even though these innovations may be suitable for the specific individual purposes to which they address, accordingly, they would not be suitable for the purposes of the present invention as heretofore described.

### SUMMARY OF THE INVENTION

AN OBJECT of the present invention is to provide a funnel for transferring a substance into and out of a canning jar that avoids the disadvantages of the prior art.

ANOTHER OBJECT of the present invention is to provide a funnel for transferring a substance into and out of a canning jar that is simple and inexpensive to manufacture.

STILL ANOTHER OBJECT of the present invention is to provide a funnel for transferring a substance into and out of a canning jar that is simple to use.

BRIEFLY STATED, STILL YET ANOTHER OBJECT of the present invention is to provide a funnel for pouring a substance into and out of a canning jar having an externally threaded mouth which comprises a hollow conical member having a large top end and a small bottom end. A collar is formed about the small bottom end of the hollow conical member. The collar has internal threads that screw onto the externally threaded mouth of the canning jar, thereby allowing the substance to be poured through the hollow conical member and into the canning jar. A pour spout is formed onto and extends downwardly from the large top end to the small bottom end of the hollow conical member, thereby allowing the substance to be poured easily out of the canning jar via the pour spout into a container.

The novel features which are considered characteristic of the present invention are set forth in the appended claims. The invention itself, however, both as to its construction and its method of operation, together with additional objects and advantages thereof, will be best understood from the following description of the specific embodiments when read and understood in connection with the accompanying drawing.

### BRIEF DESCRIPTION OF THE DRAWING

The figures of the drawings are briefly described as follows:

FIG. 1 is a top perspective view of the present invention;

FIG. 2 is a bottom perspective view of the present invention taken in the direction of arrow 2 in FIG. 1;

FIG. 3 is a top perspective view of the present invention secured to a canning jar;

FIG. 4 is a perspective view showing a substance being poured through the present invention and into a canning jar;

FIG. 5 is a perspective view showing the substance being poured out of the canning jar, via a pour spout, on the present invention and into a container;

FIG. 6 is an enlarged top perspective view showing a lid being placed onto the present invention; and

FIG. 7 is a perspective view showing a plurality of the present invention being stored.

### REFERENCE NUMERALS UTILIZED IN THE DRAWING

110 funnel
112 substance
114 canning jar
116 externally threaded mouth of canning jar 114
118 hollow conical member of funnel 110
120 large top end of hollow conical member 118
122 small bottom end of hollow conical member 118
124 collar of funnel 110
126 internal threads of collar 124
130 pour spout of funnel 110
132 container
134 sealing gasket of funnel 110
136 lid of funnel 110
138 grip lines on collar 124

### DETAILED DESCRIPTION OF THE PREFERRED EMBODIMENT

As shown in FIGS. 1, 2, and 3, the present invention is a funnel 110 for pouring a substance 112 into and out of a canning jar 114 having an externally threaded mouth 116 which comprises a hollow conical member 118 having a large top end 120 and a small bottom end 122. A collar 124 is formed about the small bottom end 122 of the hollow conical member 118.

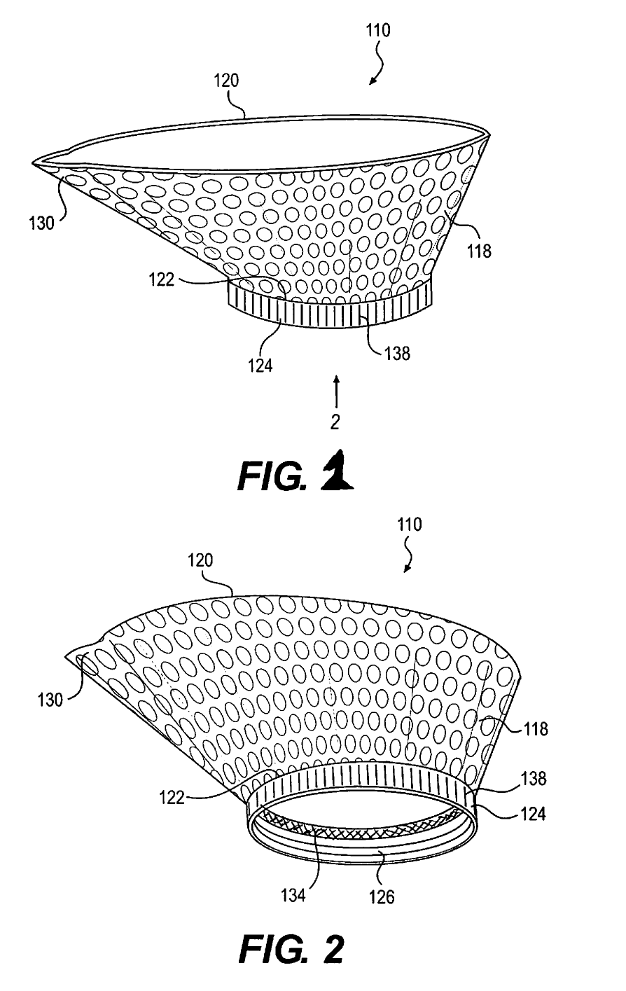

As shown in FIG. 2, the collar has internal threads 126 that screw onto the externally threaded mouth 116 of the canning jar 114.

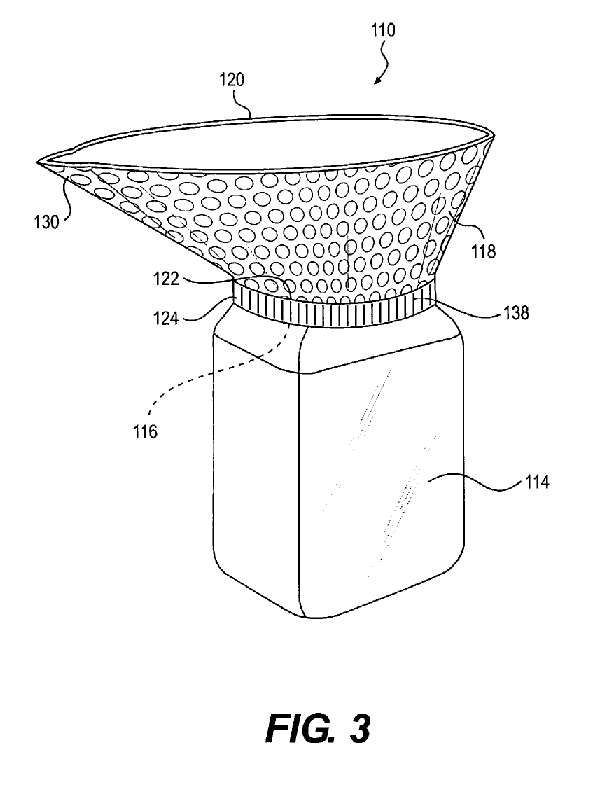

As shown in FIGS. 2-3, the funnel 110 further comprises a sealing gasket 134 secured onto an inner surface of the collar 124 above the internal threads 126 to provide a seal between the sealing gasket 134 and an upper edge of the externally threaded mouth 116 of the canning jar 114 to prevent leakage therefrom.

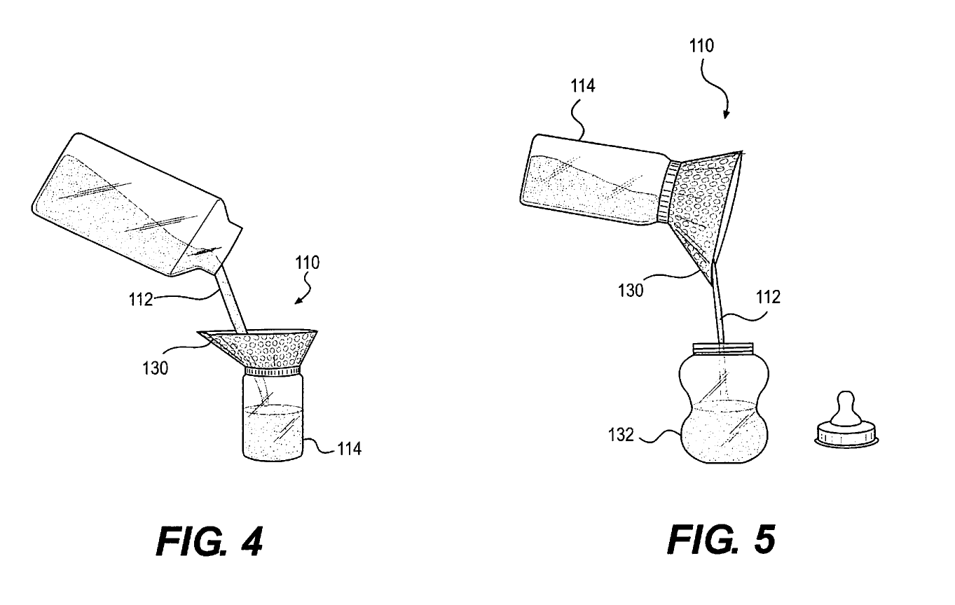

As shown in FIG. 4, the substance 112, being a liquid, can be poured through the hollow conical member 118 and into the canning jar 114. A pour spout 128 is formed onto and extends downwardly from the large top end 120 to the small bottom end 122 of the hollow conical member 118.

As shown in FIG. 5, the substance 112 can be poured easily out of the canning jar 114, via the pour spout 130, into a container 132.

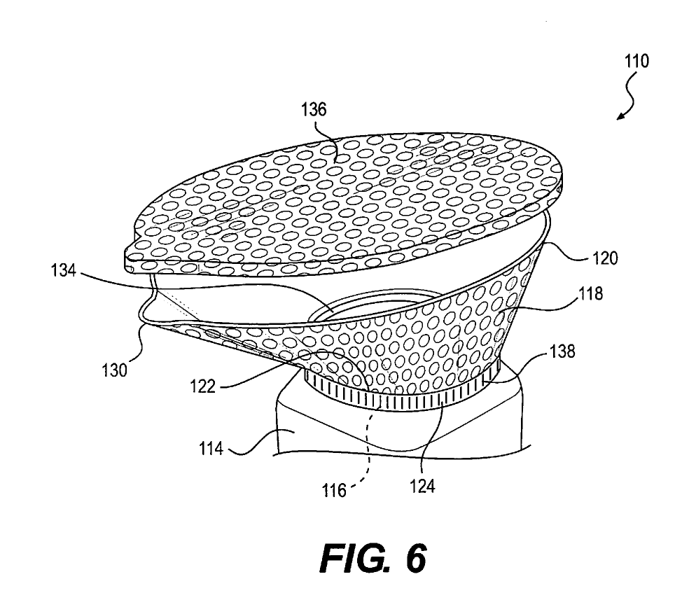

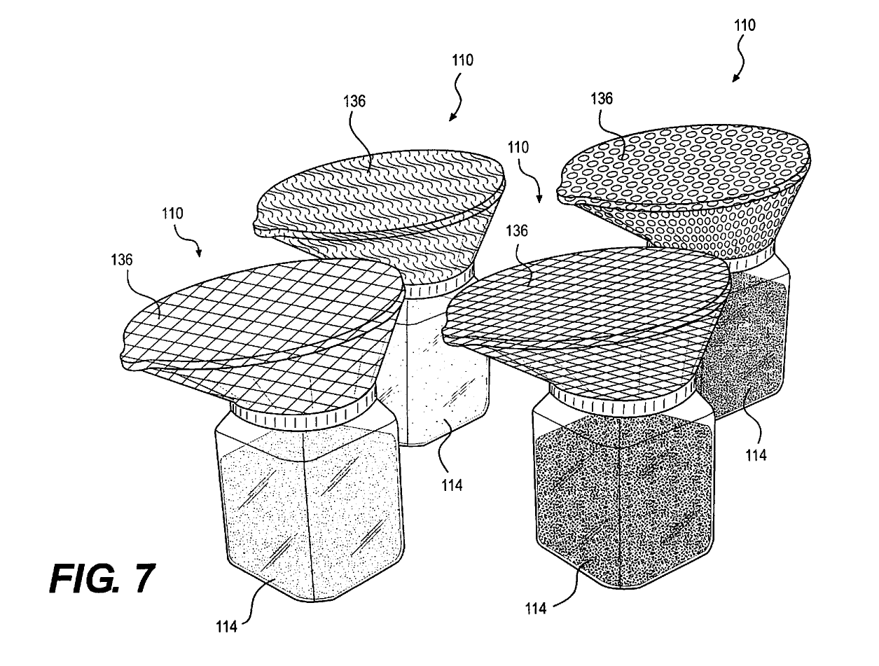

As shown in FIGS. 6 and 7, the funnel 110 further comprises a lid 136 sized to snap fit over the large top end 120 of the hollow conical member 118 and the pour spout 130 to allow the substance 112 placed within the canning jar 114 to be stored.

The collar 124 further contains a plurality of segmented grip lines 138 formed about the exterior surface to provide a better grasp of the collar 124 when being screwed onto the externally threaded mouth 116 of the canning jar 114.

The hollow conical member 118, the collar 124 and the pour spout 130 can be fabricated out of plastic or glass. The sealing gasket 134 can be fabricated out of rubber or plastic. The lid 136 can be fabricated out of plastic or glass. The funnel has a diameter of 1 inch-5 inches, thickness of 0.001-0.05 inches and the height is about 1.5 inches to 5 inches.

It will be understood that each of the elements described above, or two or more together, may also find a useful application in other types of constructions differing from the types described above.

While the invention has been illustrated and described as embodiments of a funnel for transferring a substance into and out of a canning jar, accordingly it is not limited to the details shown, since it will be understood that various omissions, modifications, substitutions and changes in the forms and details of the device illustrated and its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute characteristics of the generic or specific aspects of this invention.

The invention claimed is:

1. A funnel for pouring a substance into and out of a canning jar having an externally threaded mouth which comprises:
a) a hollow conical member having a large top end and a small bottom end;
b) a collar formed about the small bottom end of the hollow conical member, the collar having internal threads that screw onto the externally threaded mouth of the canning jar, thereby allowing the substance to be poured through the hollow conical member and into the canning jar; and
c) a pour spout formed onto and extending downwardly from the large top end to the small bottom end of the hollow conical member, thereby allowing the substance to be poured easily out of the canning jar via the pour spout into a container.

2. The funnel as recited in claim 1, further comprising a sealing gasket secured onto an inner surface of the collar above the internal threads to provide a seal between the sealing gasket and an upper edge of the externally threaded mouth of the canning jar to prevent leakage therefrom.

3. The funnel as recited in claim 1, further comprising a lid sized to snap fit over a large top end of the hollow conical member and the pour spout to allow the substance placed within the canning jar to be stored.

4. The funnel as recited in claim 1, wherein the collar further comprises a plurality of segmented grip lines formed about the exterior surface to provide a better grasp of the collar when being screwed onto the externally threaded mouth of the canning jar.

5. The funnel as recited in claim 1, wherein the hollow conical member, the collar and the pour spout are fabricated out of plastic.

6. The funnel as recited in claim 1, wherein the hollow conical member, the collar and the pour spout are fabricated out of glass.

7. The funnel as recited in claim 2, wherein the sealing gasket is fabricated out of rubber.

8. The funnel as recited in claim 2, wherein the sealing gasket is fabricated out of plastic.

9. The funnel as recited in claim 3, wherein the lid is fabricated out of plastic.

10. The funnel as recited in claim 3, wherein the lid is fabricated out of glass.

11. The funnel as recited in claim 1, wherein the funnel has a diameter of 1 inch-5 inches, thickness of 0.001-0.05 inches and the height is about 1.5 inches to 5 inches.
